(19) United States
(12) Patent Application Publication
(10) Pub. No.: US 2022/0056242 A1
(43) Pub. Date: Feb. 24, 2022

(54) TIRE PROVIDED WITH AN OUTER SIDEWALL, THE COMPOSITION OF WHICH CONTAINS A THERMOPLASTIC ELASTOMER AND A POLYETHYLENE OXIDE

(71) Applicant: COMPAGNIE GENERALE DES ETABLISSEMENTS MICHELIN, Clermont-Ferrand Cedex (FR)

(72) Inventors: CHRISTOPHE CHOUVEL, Clermont-Ferrand (FR); DAVID GONZALEZ, Clermont-Ferrand (FR); SYLVAIN MAYER, Clermont-Ferrand (FR)

(21) Appl. No.: 17/416,628

(22) PCT Filed: Dec. 18, 2019
(86) PCT No.: PCT/FR2019/053156

§ 371 Date: Jun. 21, 2021

(30) Foreign Application Priority Data
Dec. 21, 2018 (FR) 1873941
Jan. 31, 2019 (FR) 1900920

(51) Int. Cl. C08L 7/00; B60C 1/00

(52) U.S. Cl. CPC C08L 7/00; C08L 2312/00; C08L 2205/03; B60C 1/0025

(57) ABSTRACT

A tire is provided with an outer sidewall, said outer sidewall comprising at least one composition based on at least one thermoplastic elastomer comprising at least one elastomer block and at least one thermoplastic block, a butadiene elastomer, 10 to 100 phr of carbon black, 0.6 to 1.9 phr of polyethylene oxide with a weight-average molecular weight Mw within a range extending from 250 to 550 g/mol, and a crosslinking system.

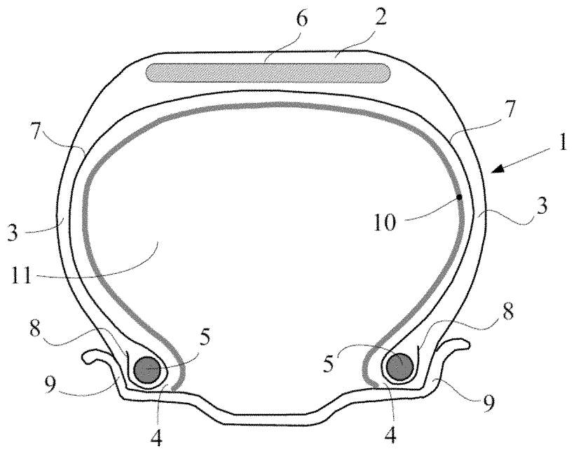

The present invention relates to pneumatic tyres and more particularly to tyre outer sidewalls, that is to say, by definition, to the elastomeric layers located radially on the outside of the tyre, which are in contact with the ambient air.

This is because it is possible to define, within the tyre, three types of regions:
The radially exterior region in contact with the ambient air, this region essentially consisting of the tread and of the outer sidewall of the tyre. An outer sidewall is an elastomeric layer positioned outside the carcass reinforcement relative to the internal cavity of the tyre, between the crown and the bead, so as to completely or partially cover the region of the carcass reinforcement extending from the crown to the bead.
The radially interior region in contact with the inflation gas, this region generally consisting of the layer airtight to the inflation gases, sometimes referred to as inner liner.
The internal region of the tyre, that is to say that between the exterior and interior regions. This region includes layers or plies which are referred to here as internal layers of the tyre. These are, for example, carcass plies, tread sublayers, tyre belt plies or any other layer which is not in contact with the ambient air or the inflation gas of the tyre.

As illustrated by numerous documents, among which may be mentioned documents EP1097966, EP1462479B1, EP1975200A1, EP1033265B1, EP1357149A2, EP1231080A1 and U.S. Pat. No. 4,824,900, the compositions conventionally used for sidewalls are based on natural rubber and on synthetic rubber, such as polybutadiene, and on carbon black.

For tyre manufacturers, the composition of a tyre sidewall must have many characteristics that are sometimes difficult to reconcile, and in particular good resistance to external attacks such as impacts, tears and other perforations. Document W02018/100079 proposes a solution consisting in using, as tyre sidewall, a rubber composition comprising a blend of diene elastomer and of thermoplastic elastomer.

It is also important for the tyre sidewalls to have good resistance to ozone attacks. A known solution is to add an anti-ozone wax to the composition. However, it still remains advantageous to find solutions for improving resistance to ozone attacks in the sidewalls of tyres.

In this context, a solution provided by the applicants, which makes it possible to obtain tyres which exhibit improved properties of stiffness, of hysteresis and of resistance to ozone attacks consists in using new sidewall compositions as explained below.

A subject of the presently proposed invention is a tyre provided with an outer sidewall, said outer sidewall comprising at least one composition based on at least one thermoplastic elastomer comprising at least one elastomer block and at least one thermoplastic block, a butadiene elastomer, 10 to 100 phr of carbon black, 0.6 to 1.9 phr of polyethylene oxide with a weight-average molecular weight Mw within a range extending from 250 to 550 g/mol, and a crosslinking system.

The invention relates more particularly to pneumatic tyres intended to equip motor vehicles of passenger vehicle type, SUVs (“Sport Utility Vehicles”), or two-wheel vehicles (in particular motorcycles), or aircraft, or also industrial vehicles selected from vans, heavy-duty vehicles, that is to say underground trains, buses, heavy road transport vehicles (lorries, tractors, trailers) or off-road vehicles, such as heavy agricultural vehicles or civil engineering equipment, and other transportation and handling vehicles.

The invention and its advantages will be easily understood in the light of the description and implementational examples which follow, and also of the single figure relating to these examples, which diagrammatically represents, in radial cross section, a pneumatic tyre in accordance with the invention.

The expression “composition based on” should be understood as meaning a composition including the mixture and/or the product of the in situ reaction of the various base constituents used, some of these constituents being able to react and/or being intended to react with each other, at least partially, during the various phases of manufacture of the composition or during the subsequent curing, modifying the composition as it is prepared at the start. Thus, the compositions as employed for the invention can be different in the non-crosslinked state and in the crosslinked state.

Moreover, the term “phr”, well known to those skilled in the art, means, for the purposes of the present patent application, parts by weight per hundred parts of elastomers; that is to say of the total weight of the elastomer(s), whatever they may be, this therefore including thermoplastic elastomers and diene elastomers in particular.

In the present description, unless expressly indicated otherwise, all the percentages (%) shown are mass percentages. Furthermore, any interval of values denoted by the expression “between a and b” represents the range of values extending from more than a to less than b (that is to say, limits a and b excluded), while any interval of values denoted by the expression “from a to b” means the range of values extending from a up to b (that is to say, including the strict limits a and b).

When reference is made to a “predominant” compound, this is understood to mean, for the purposes of the present invention, that this compound is predominant among the compounds of the same type in the composition, that is to say that it is the one which represents the greatest amount by mass among the compounds of the same type. Thus, for example, a predominant polymer is the polymer representing the greatest weight with respect to the total weight of the polymers in the composition. In the same way, a “predominant” filler is that representing the greatest weight among the fillers of the composition. By way of example, in a system comprising just one polymer, the latter is predominant for the purposes of the present invention and, in a system comprising two polymers, the predominant polymer represents more than half of the weight of the polymers. On the contrary, a “minor” compound is a compound which does not represent the greatest weight fraction among the compounds of the same type.

For the purposes of the present invention, when reference is made to a “predominant” unit (or monomer) within one and the same compound (or polymer), this is understood to mean that this unit (or monomer) is predominant among the units (or monomers) forming the compound (or polymer), that is to say that it is the one which represents the greatest fraction by weight among the units (or monomers) forming the compound (or polymer). Thus, for example, a resin predominantly composed of units resulting from C₅ monomers is a resin in which the C₅ units represent the greatest amount by weight among all the units making up said resin. In other words, a “predominant” monomer or an assembly of “predominant” monomers is a monomer (or an assembly of monomers) which represents the largest weight fraction in the polymer. On the contrary, a “minor” monomer is a monomer which does not represent the largest molar fraction in the polymer.

The compounds mentioned in the description may be of fossil or biobased origin. In the latter case, they can result, partially or completely, from biomass or be obtained from renewable starting materials resulting from biomass. Polymers, plasticizers, fillers, and the like, are concerned in particular.

Outer Sidewall Elastomer Composition

An essential feature of the tyre according to the invention is that it is provided with an outer sidewall, said outer sidewall comprising at least one composition based on at least one thermoplastic elastomer comprising at least one elastomer block and at least one thermoplastic block, a butadiene elastomer, 10 to 100 phr of carbon black, 0.6 to 1.9 phr of polyethylene oxide with a weight-average molecular weight Mw within a range extending from 250 to 550 g/mol, and a crosslinking system.

Elastomers

As is normal, the terms “elastomer” and “rubber”, which are interchangeable, are used without distinction in the text. The composition of the sidewall of the tyre of the invention is based on at least one thermoplastic elastomer comprising at least one elastomer block and at least one thermoplastic block, and at least one butadiene elastomer.

Thermoplastic elastomer (TPE) is understood to mean, in a known way, a polymer with a structure which is intermediate between a thermoplastic polymer and an elastomer.

A thermoplastic elastomer consists of one or more rigid “thermoplastic” segments connected to one or more flexible “elastomer” segments.

Thus, the thermoplastic elastomer(s) of the composition of the outer sidewall which can be used according to the invention comprise at least one elastomer block and at least one thermoplastic block.

Elastomers of this type are well known to those skilled in the art and, for example, are described in document WO 2018/100079 for use thereof in a tyre sidewall.

Thus, a composition in which a resin or a thermoplastic polymer and an elastomer are mixed does not constitute a thermoplastic elastomer for the purposes of the present invention.

The elastomer blocks of the thermoplastic elastomers that can be used according to the invention can be any elastomer known to those skilled in the art. A distinction is generally made between saturated elastomer blocks and unsaturated elastomer blocks.

Saturated elastomer block is understood to mean that this block essentially comprises units not comprising ethylenic unsaturations (that is to say, carbon-carbon double bonds), that is to say that the units comprising ethylenic unsaturations represent less than 15 mol %, with respect to all of the units of the block under consideration. The saturated elastomer blocks are generally formed by the polymerization of ethylenic monomers. Mention may in particular be made of polyalkylene blocks such as random ethylene-propylene or ethylene-butylene copolymers. These saturated elastomer blocks can also be obtained by hydrogenation of unsaturated elastomer blocks.

The term “unsaturated elastomer block” is intended to mean that this block is at least partially derived from conjugated diene monomers, having a content of moieties or units of diene origin (conjugated dienes) which is greater than 15% mol %.

When the elastomer blocks of the thermoplastic elastomers which can be used according to the invention are unsaturated, they are preferentially selected from:
a) any homopolymer obtained by polymerization of a conjugated diene monomer containing from 4 to 12 carbon atoms;

b) any copolymer obtained by copolymerization of one or more conjugated dienes with one another or with one or more vinylaromatic compounds having from 8 to 20 carbon atoms.
Conjugated dienes that are suitable are in particular isoprene, 1,3-butadiene, piperylene, 1-methylbutadiene, 2-methylbutadiene, 2,3-dimethyl-1,3-butadiene, 2,4-dimethyl-1,3-butadiene, 1,3-pentadiene, 2-methyl-1,3-pentadiene, 3-methyl-1,3-pentadiene, 4-methyl-1,3-pentadiene, 2,3-dimethyl-1,3-pentadiene, 2,5-dimethyl-1,3-pentadiene, 2-methyl-1,4-pentadiene, 1,3-hexadiene, 2-methyl-1,3-hexadiene, 2-methyl-1,5-hexadiene, 3-methyl-1,3-hexadiene, 4-methyl-1,3-hexadiene, 5-methyl-1,3-hexadiene, 2,5-dimethyl-1,3-hexadiene, 2,5-dimethyl-2,4-hexadiene, 2-neopentyl-1,3-butadiene, 1,3-cyclopentadiene, methylcyclopentadiene, 2-methyl-1,6-heptadiene, 1,3-cyclohexadiene, 1-vinyl-1,3-cyclohexadiene, and a mixture of these conjugated dienes; preferably these conjugated dienes are selected from isoprene, butadiene and a mixture containing isoprene and/or butadiene.

According to an alternative form, the monomers polymerized in order to form an unsaturated elastomer block can be randomly copolymerized with at least one other monomer so as to form an unsaturated elastomer block. According to this alternative form, the molar fraction of polymerized monomer other than a diene monomer, with respect to the total number of units of the unsaturated elastomer block, has to be such that this block retains its unsaturated elastomer properties. Advantageously, the molar fraction of this other comonomer can range from 0% to 50%, more preferentially from 0% to 45% and even more preferentially from 0% to 40%.

By way of illustration, this other monomer capable of copolymerizing with the first monomer can be selected from ethylenic monomers, such as ethylene, propylene or butylene, monomers of vinylaromatic type having from 8 to 20 carbon atoms as defined below, or else it can be a monomer such as vinyl acetate.

Styrene monomers, namely methylstyrenes, para-(tert-butyl)styrene, chlorostyrenes, bromostyrenes, fluorostyrenes or also para-hydroxystyrene, are suitable in particular as vinylaromatic compounds. Preferably, the comonomer of vinylaromatic type is styrene.

Thus, according to a preferential embodiment, the at least one elastomer block can be a random copolymer of styrene/butadiene (SBR) type, it being possible for this copolymer to be partially hydrogenated. This SBR block preferably has a Tg (glass transition temperature) measured by DSC according to Standard ASTM D3418 of 1999, of less than −50° C. In a well-known manner, the SBR block comprises a styrene content, a content of 1,2- bonds of the butadiene part and a content of 1,4- bonds of the butadiene part, the latter being composed of a content of trans-1,4- bonds and a content of cis-1,4- bonds when the butadiene part is not hydrogenated. Preferentially, use is made in particular of an SBR block having a styrene content, for example, within a range extending from 10% to 60% by weight, preferably from 20% to 50% by weight, and, for the butadiene part, a content of 1,2- bonds within a range extending from 4% to 75% (mol %) and a content of 1,4- bonds within a range extending from 20% to 96% (mol %).

The degree of hydrogenation is determined by an NMR analysis. The spectra are acquired on a Bruker Avance 500 MHz spectrometer equipped with a 5 mm 1H—X Cryoprobe. The quantitative ¹H NMR experiment uses a simple 30° pulse sequence and a repetition time of 5 seconds between each acquisition. 64 accumulations are carried out. The samples (approximately 25 mg) are dissolved in approximately 1 ml of CS2; 100 μl of deuterated cyclohexane are added to form the lock during the acquisition. The chemical shifts are calibrated with respect to the protonated impurity of the CS₂ ¹H δ ppm at 7.18 ppm, with reference to TMS (¹H δ ppm at 0 ppm). The ¹H NMR spectrum makes it possible to quantify the microstructure by integration of the broad unresolved peaks of signals characteristic of the different units:
The styrene originating from the SBR and the polystyrene blocks. It is quantifiable in the region of aromatics between 6.0 ppm and 7.3 ppm for 5 protons (with subtraction of the integral of the signal of the CS₂ impurity at 7.18 ppm).
The 1,2 PB originating from the SBR. It is quantifiable in the region of ethylenics between 4.6 ppm and 5.1 ppm for 2 protons.
The 1,4 PB originating from the SBR. It is quantifiable in the region of ethylenics between 5.1 ppm and 6.1 ppm for 2 protons and with deletion of 1 proton of the 1,2-PB unit.
The hydrogenated 1,2 PB originating from the hydrogenation and only exhibiting aliphatic protons. The pendent CH₃ groups of the hydrogenated 1,2-PB were identified and are quantifiable in the region of aliphatics between 0.4 and 0.8 ppm for 3 protons.
The hydrogenated 1,4 PB originating from the hydrogenation and only exhibiting aliphatic protons. It will be deduced by subtracting the aliphatic protons of the various units, considering it for 8 protons.

The microstructure can be quantified in mol % as follows: mol % of a unit=¹H integral of a unit/Z(¹H integrals of each unit). For example, for a styrene unit: mol % of styrene=CH integral of styrene)/(¹H integral of styrene+¹H integral of 1,2-PB +¹H integral of 1,4-PB +¹H integral of hydrogenated 1,2-PB+¹H integral of hydrogenated 1,4-PB).

Preferably, in the thermoplastic elastomers of use for the requirements of the invention, the SBR elastomer block is hydrogenated in such a way that a proportion ranging from 10 mol % to 50 mol % of the double bonds in the butadiene portion are hydrogenated.

Preferably for the invention, the elastomer blocks of the thermoplastic elastomers have a number-average molecular weight (Mn) ranging from 25 000 g/mol to 350 000 g/mol, preferably from 35 000 g/mol to 250 000 g/mol, so as to confer, on the thermoplastic elastomers, good elastomeric properties and a mechanical strength which is sufficient and compatible with the use as a tyre outer sidewall.

Particularly preferably in the invention, the unsaturated elastomer block(s) are selected from the group consisting of polyisoprenes, polybutadienes, styrene/butadiene copolymers, and mixtures of these elastomers, these elastomers being non-hydrogenated or partially hydrogenated.

As explained above, the thermoplastic elastomers which can be used according to the invention comprise at least one thermoplastic block.

Thermoplastic block is understood to mean a block formed of polymerized monomers and having a glass transition temperature, or a melting point in the case of semicrystalline polymers, of greater than or equal to 80° C., preferably varying from 80° C. to 250° C., more preferentially varying from 80° C. to 200° C. and in particular varying from 80° C. to 180° C.

This is because, in the case of a semicrystalline polymer, a melting point greater than the glass transition temperature may be observed. In this case, the melting point and not the glass transition temperature is taken into account for the above definition.

The thermoplastic block(s) can be formed from polymerized monomers of various natures.

In particular, the thermoplastic block(s) can be selected from the group consisting of polyolefins (polyethylene, polypropylene), polyurethanes, polyamides, polyesters, polyacetals, polyethers (polyethylene oxide, polyphenylene ether), polyphenylene sulfides, polyfluorinated compounds (FEP, PFA, ETFE), polystyrenes, polycarbonates, polysulfones, poly(methyl methacrylate), polyetherimide, thermoplastic copolymers such as the acrylonitrile/butadiene/styrene copolymer (ABS), and mixtures of these polymers.

The thermoplastic block(s) can be selecting preferentially from polystyrenes and polymers comprising at least one polystyrene block.

As regards the polystyrenes, the latter are obtained from styrene monomers.

Styrene monomer should be understood as meaning, in the present description, any monomer comprising styrene, both unsubstituted or substituted; mention may be made, among substituted styrenes, for example, of methylstyrenes (for example, o-methylstyrene, m-methylstyrene or p-methylstyrene, a-methylstyrene, α,2-dimethylstyrene, α,4-dimethylstyrene or diphenylethylene), para-(tert-butyl)styrene, chlorostyrenes (for example, o-chlorostyrene, m-chlorostyrene, p-chlorostyrene, 2,4-dichlorostyrene, 2,6-dichlorostyrene or 2,4,6-trichlorostyrene), bromostyrenes (for example, o-bromostyrene, m-bromostyrene, p-bromostyrene, 2,4-dibromostyrene, 2,6-dibromostyrene or 2,4,6-tribromostyrene), fluorostyrenes (for example, o-fluorostyrene, m-fluorostyrene, p-fluorostyrene, 2,4-difluorostyrene, 2,6-difluorostyrene or 2,4,6-trifluorostyrene) or else para-hydroxystyrene.

According to a preferential embodiment of the invention, the content by weight of styrene in the thermoplastic elastomers which can be used according to the invention is between 5% and 50%, preferentially between 10% and 40%.

The proportion of thermoplastic blocks in the thermoplastic elastomers which can be used according to the invention is determined, on the one hand, by the thermoplasticity properties which the thermoplastic elastomers should exhibit.

The thermoplastic block(s) are preferentially present in sufficient proportions to preserve the thermoplastic nature of the thermoplastic elastomers which can be used according to the invention. The minimum content of thermoplastic blocks in the thermoplastic elastomers can vary as a function of the conditions of use of the thermoplastic elastomers.

On the other hand, the ability of the thermoplastic elastomers to deform during the preparation of the tyre can also contribute to determining the proportion of the thermoplastic blocks in the thermoplastic elastomers which can be used according to the invention.

Particularly preferably in the invention, the thermoplastic block(s) are selected from the group consisting of polystyrenes, polyesters, polyamides, polyurethanes, and mixtures of these polymers.

Very particularly preferably in the invention, the thermoplastic block(s) are selected from the group consisting of polystyrenes, polyesters, polyamides and mixtures of these polymers.

Preferably in the invention, the thermoplastic elastomer(s) are selected from the group consisting of styrene/butadiene/styrene (SBS), styrene/isoprene/styrene (SIS) and styrene/optionally partially hydrogenated butadiene-styrene copolymer/styrene (SOE) block copolymers and mixtures of these copolymers.

More preferentially, the thermoplastic elastomer(s) are selected from the group consisting of styrene/butadiene/styrene (SBS) block copolymers, styrene/optionally partially hydrogenated butadiene-styrene/styrene (SOE) block copolymers, and mixtures of these copolymers.

According to another variant, the thermoplastic elastomer(s) are selected from the group consisting of styrene/butadiene/styrene (SBS) block copolymers, styrene/isoprene/styrene (SIS) block copolymers, styrene/partially hydrogenated butadiene-styrene copolymer/styrene (SOE) block copolymers, and mixtures of these copolymers.

Particularly preferably, the thermoplastic elastomer(s) are selected from the group consisting of styrene/butadiene/styrene (SBS) block copolymers, styrene/partially hydrogenated butadiene-styrene copolymer/styrene (SOE) block copolymers, and mixtures of these copolymers.

Mention may be made, by way of examples of commercially available thermoplastic elastomers which can be used according to the invention, of the elastomers of SIS type sold by Kuraray under the name “Hybrar 5125” or sold by Kraton under the name “D 1161”, or also of the elastomers of linear SBS type sold by Polimeri Europa under the name “Europrene SOL T 166” or of star-branched SBS type sold by Kraton under the name “D1184”. Mention may also be made of the elastomers sold by Dexco Polymers under the Vector name (e.g. “Vector 4114” or “Vector 8508”).

Preferably, the content of thermoplastic elastomer comprising at least one elastomer block and at least one thermoplastic block in the composition is within a range extending from 5 to 45 phr, more preferentially from 10 to 40 phr, even more preferentially from 15 to 35 phr.

Preferably, the content of butadiene elastomer in the composition which can be used in the sidewall of the tyre according to the invention is within a range extending from 55 to 95 phr, preferably from 60 to 90 phr, more preferentially from 65 to 85 phr..

Butadiene elastomer is understood to mean all the elastomers predominantly consisting of butadiene monomers. Preferably, the butadiene elastomer is selected from the group consisting of butadiene polymers, butadiene copolymers and mixtures thereof. Among butadiene copolymers, mention may be made of those comprising, as minor comonomer, styrene (SBR), isoprene (BIR) or styrene and isoprene (SBIR).

All polybutadienes are suitable and in particular those having a content (mol %) of 1,2- units of between 4% and 80% or those having a cis-1,4- content (mol %) of greater than 80%.

Also suitable are all butadiene/styrene copolymers and in particular those having a glass transition temperature, Tg, (measured according to ASTM D3418) of between 0° C. and −70° C. and more particularly between −10° C. and −60° C., a styrene content of between 5% and 60% by weight and more particularly between 20% and 50%, a content (mol %) of 1,2- bonds of the butadiene part of between 4% and 75% and a content (mol %) of trans-1,4- bonds of between 10% and 80%.

Also suitable are butadiene/isoprene copolymers, those having an isoprene content between 5% and 50% by weight and a Tg of −40° C. to −80° C.

In the case of butadiene/styrene/isoprene copolymers, suitable as butadiene elastomer are in particular those having a butadiene content which is greater than the styrene and isoprene content.

More preferably, the butadiene elastomer is selected from the group consisting of polybutadiene (BR), butadiene/styrene copolymers (SBRs) and mixtures thereof. Very preferably, the butadiene elastomer is polybutadiene.

Preferably, for the invention, the thermoplastic and butadiene elastomers are the only elastomers of the composition, which means that the sum of their contents in phr is 100 phr.

Carbon black and fillers

The composition of the outer sidewall of the tyre of the invention comprises from 10 to 100 phr of carbon black.

Use may be made of any type of carbon black known for its abilities to reinforce a rubber composition which can be used in the manufacture of tyres.

Any carbon black conventionally used in tyres (“tyre-grade” blacks) is suitable as carbon blacks. Mention will more particularly be made, for example, of the reinforcing carbon blacks of ASTM grade N115, N134, N234, N326, N330, N339, N347 or N375, or else, depending on the applications targeted, the blacks of higher series (for example N550, N660, N683 or N772), indeed even N990.

In the case of the use of carbon blacks with an isoprene elastomer, the carbon blacks might, for example, be already incorporated in the isoprene elastomer in the form of a masterbatch (see, for example, applications WO 97/36724 and WO 99/16600).

Preferably, for the invention, use may be made of a carbon black having a high specific surface area. The term “specific surface area” means herein the BET specific surface area measured according to Standard ASTM D6556-09 [multipoint (5 point) method - gas: nitrogen - relative pressure P/PO range: 0.05 to 0.30].

Thus, for the requirements of the invention, in the composition of the outer sidewall, from 10 to 100 phr of the carbon black, preferably from 10 to 45 phr, exhibits a specific surface of greater than 60 m²/g, preferably of greater than 80 m²/g. More preferably, from 10 to 100 phr of the carbon black, preferably from 10 to 45 phr, exhibits a specific surface of greater than 90 m²/g, preferably of greater than 110 m²/g.

Preferably, in the composition of the outer sidewall of the tyre of the invention, the total amount of carbon black is within a range extending from 20 to 60 phr, preferably from 25 to 55 phr.

Preferably, for the invention, the carbon black is the only reinforcing filler in the composition of the outer sidewall of the tyre, preferably the only filler.

Alternatively and complementarily, the composition of the outer sidewall of the tyre of the invention can comprise another filler, optionally a reinforcing filler, preferably at a total content of less than 20 phr, more preferably of less than 15 phr.

Suitable as such are organic fillers other than carbon black, reinforcing inorganic fillers or also non-reinforcing fillers.

Mention may made, as examples of organic fillers other than carbon blacks, of functionalized polyvinylaromatic organic fillers, as described in applications WO-A-2006/069792 and WO-A-2006/069793.

Mineral fillers of the siliceous type, in particular silica (SiO₂), or of the aluminous type, in particular alumina (Al₂O₃), are notably suitable for use as reinforcing mineral fillers. The silica used may be any reinforcing silica known to those skilled in the art, especially any precipitated or fumed silica with a BET surface area and a CTAB specific surface area that are both less than 450 m²/g, preferably from 30 to 400 m²/g. Mention will be made, as highly dispersible precipitated silicas (HDSs), for example, of the “Ultrasil 7000” and “Ultrasil 7005” silicas from Degussa, the “Zeosil 1165MP, 1135MP and 1115MP” silicas from Rhodia, the “Hi-Sil EZ150G” silica from PPG, the “Zeopol 8715, 8745 and 8755” silicas from Huber or the silicas with a high specific surface area as described in application WO 03/16837.

In order to couple the reinforcing mineral filler to the diene elastomer, use is made, in a known manner, of an at least difunctional coupling agent (or bonding agent) intended to provide a satisfactory connection, of chemical and/or physical nature, between the mineral filler (surface of its particles) and the diene elastomer, in particular difunctional organosilanes or polyorga nosiloxa nes.

Mention may be made, as non-reinforcing filler, of those selected from the group consisting of calcium carbonate, kaolin, montmorillonite, aluminium silicate, magnesium silicate and mixtures thereof.

Polyethylene Oxide

The composition of the outer sidewall of the tyre of the invention comprises from 0.6 to 1.9 phr of polyethylene oxide with a weight-average molecular weight (Mw) within a range extending from 250 to 550 g/mol.

This is because the applicants have found that such an amount of such a polyethylene oxide allows the tyre sidewall compositions to exhibit an excellent balance of ozone resistance performance, without aesthetic degradation or degradation to the feel, of the composition after curing. In comparison, polyethylene oxides with a weight Mw of less than 250 g/mol and a Mw of greater than 550 g/mol prove to be less effective, or even ineffective.

As is well known to those skilled in the art, polyethylene oxides, sometimes also referred to as poly(ethylene oxide)s, polyethylene-oxides (PEOs), polyethylene glycols (PEGS) are polymers of the type of a polyether of glycol of general formula HO—(CH₂—CH₂—O)ₙH.

Sometimes the polyethylene oxides can be modified, for example functionalized or substituted, for example by alkyl radicals to form polyethylene oxide derivatives such as alkyl-PEGs. Likewise, propylene glycol (PPG) polymerization products can be copolymerized to form block copolymers. For the purposes of the invention, the term “polyethylene oxide” is understood in the strict sense, that is to say unmodified.

Polyethylene oxides are used in a large number of applications such as cosmetics or pharmacy. More rarely, these products can be used in tyres, and even more rarely in tyre sidewalls.

Polyethylene oxides, depending on the length of their chains, can exhibit various characteristics in terms of melting point or molecular weight.

Polyethylene oxides are commercially available and are noted, for example, PEG-1000 or PEG-600 for polyethylene oxides with a weight-average molecular weight Mw of 1000 g/mol or 600 g/mol, respectively.

For the needs of the invention, the composition must comprise a specific polyethylene oxide with a weight-average molecular weight Mw within a range extending from 250 to 550 g/mol, preferably from 300 to 500 g/mol and more preferentially from 350 to 450 g/mol, in particular of approximately 400 g/mol, such as, for example, PEG-400.

Preferentially for the needs of the invention, the composition comprises 0.7 to 1.8 phr of the specific polyethylene oxide, more preferentially from 0.8 to 1.7 phr. Above an amount of 1.9 phr, the polyethylene oxide exudes at the surface of the composition, penalizing the feel.

Anti-Ozone Wax

The composition of the outer sidewall of the tyre of the invention optionally comprises from 0.2 to 10 phr of anti-ozone wax.

When a wax is used, an additional advantage of the invention is that it reduces the problem of “blooming”, well known to those skilled in the art, and due to the migration of anti-ozone waxes to the surface of the compositions.

Anti-ozone waxes are well known to those skilled in the art. These film-forming anti-ozonant waxes can, for example, be paraffinic waxes, microcrystalline waxes or mixtures of paraffinic and microcrystalline waxes. They consist of a mixture of linear alkanes and of non-linear alkanes (isoalkanes, cycloalkanes, branched alkanes) resulting from the refining of oil or from the catalytic hydrogenation of carbon monoxide (Fischer-Tropsch process) predominantly comprising chains of at least 20 carbon atoms.

All the anti-ozonant waxes known to those skilled in the art can be used, including natural waxes, such as, for example, candelilla wax or carnauba wax. These waxes can, furthermore, be used as blends.

Mention may be made of the commercial waxes “Varazon 4959” or “Varazon 6500” or also “Varazon 6810” from Sasol, “Ozoace 0355” from Nippon Seiro, “Negozone 9343” from H&R and “H3841” from Yanggu Huatai.

Preferably, the anti-ozone wax contains from 50% to 75% of linear alkanes comprising from 30 carbon atoms to 38 carbon atoms, with respect to the total amount of linear alkanes.

Preferably, in the composition of the outer sidewall of the tyre of the invention, the amount of anti-ozone wax is within a range extending from 0.5 to 5 phr, more preferably from 0.5 to 3 phr. More preferentially, the amount of anti-ozone wax is within a range extending from 0.7 to 3 phr, preferably from 1.2 to 2.8 phr.

Crosslinking System

The crosslinking system can be a vulcanization system; it is preferably based on sulfur (or sulfur donor) and on a primary vulcanization accelerator. Additional to this vulcanization system are optionally various known secondary vulcanization accelerators or vulcanization activators (preferably for 0.5 to 5.0 phr each), such as zinc oxide, stearic acid, guanidine derivatives (in particular diphenylguanidine), and the like. The sulfur or a sulfur donor is used at a preferred content of between 0.5 and 10 phr, more preferably between 0.5 and 5.0 phr, for example between 0.5 and 3.0 phr, when the invention is applied to a tyre outer sidewall. Mention may be made, among sulfur donors, for example, of alkylphenol disulfides (APDSs), such as, for example, para-(tert-butyl)phenol disulfide.

Use may be made, as (primary or secondary) accelerator, of any compound capable of acting as accelerator of the vulcanization of diene elastomers in the presence of sulfur, in particular accelerators of the thiazole type and their derivatives and accelerators of the thiuram and zinc dithiocarbamate types. These accelerators are more preferably selected from the group consisting of 2-mercaptobenzothiazole disulfide (abbreviated to “MBTS”), N-cyclohexyl-2-benzothiazolesulfenamide (abbreviated to “CBS”), N,N-dicyclohexyl-2-benzothiazolesulfenamide (abbreviated to “DCBS”), N-(tert-butyl)-2-benzothiazolesulfenamide (abbreviated to “TBBS”), N-(tert-butyl)-2-benzothiazolesulfenimide (abbreviated to “TBSI”), zinc dibenzyldithiocarbamate (abbreviated to “ZBEC”) and mixtures of these compounds. Preferably, use is made of a primary accelerator of the sulfenamide type.

Various Sdditives

The outer sidewall composition described above can furthermore comprise the various additives normally present in the outer sidewalls known to those skilled in the art. Mention will be made, for example, of protective agents, such as antioxidants or antiozonants, UV stabilizers, various processing aids or other stabilizers, or else promoters capable of promoting the adhesion to the remainder of the structure of the pneumatic object.

Plasticizers—Resin and Oil

Hydrocarbon-Based Resin

The composition of the outer sidewall of the tyre of the invention can also comprise a hydrocarbon-based resin, also called plasticizing resin.

It is recalled here that the designation “resin” is reserved in the present patent application, by definition known to those skilled in the art, for a compound which is solid at ambient temperature (23° C.), in contrast to a liquid plasticizing compound, such as an extender oil or plasticizing oil. At ambient temperature (23° C.), these oils, which are more or less viscous, are liquids (that is to say, as a reminder, substances which have the ability to eventually assume the shape of their container), in contrast especially to resins or rubbers, which are by nature solids.

Hydrocarbon-based resins are polymers well known to a person skilled in the art, essentially based on carbon and hydrogen, which can be used in particular as plasticizing agents in polymer matrices. They have been described, for example, in the book entitled “Hydrocarbon Resins” by R. Mildenberg, M. Zander and G. Collin (New York, VCH, 1997, ISBN 3-527-28617-9), Chapter 5 of which is devoted to their applications, notably in the tyre rubber field (5.5. “Rubber Tires and Mechanical Goods”). They can be aliphatic, cycloaliphatic, aromatic, hydrogenated aromatic, of the aliphatic/aromatic type, that is to say based on aliphatic and/or aromatic monomers. They can be natural or synthetic, based or not based on petroleum (if such is the case, also known under the name of petroleum resins). They are by definition miscible (i.e., compatible) at the contents used with the polymer compositions for which they are intended, so as to act as true diluents. Their Tg is preferably greater than 0° C., in particular greater than 20° C. (most often between 30° C. and 120° C.).

In a known way, these hydrocarbon-based resins can also be described as thermoplastic resins in the sense that they soften when heated and can thus be moulded. They can also be defined by a softening point, the temperature at which the product, for example in the powder form, sticks together. The softening point of a hydrocarbon-based resin is generally greater by approximately 50 to 60° C. than its Tg value.

The thermoplastic hydrocarbon-based resins may be aliphatic or aromatic or else of the aliphatic/aromatic type, that is to say based on aliphatic and/or aromatic monomers. They can be natural or synthetic, based or not based on petroleum (if such is the case, also known under the name of petroleum resins).

Suitable as aromatic monomers are, for example: styrene, a-methylstyrene, ortho-, meta- or para-methylstyrene, vinyltoluene, para-(tert-butyl)styrene, methoxystyrenes, chlorostyrenes, vinylmesitylene, divinylbenzene, vinylnaphthalene or any vinylaromatic monomer resulting from a C₉ fraction (or more generally from a C₈ to C₁₀ fraction). Preferably, the vinylaromatic monomer is styrene or a vinylaromatic monomer resulting from a C₉ fraction (or more generally from a C₈ to C₁₀ fraction). Preferably, the vinylaromatic monomer is the minor monomer, expressed as molar fraction, in the copolymer under consideration.

According to one particularly preferential embodiment, the plasticizing hydrocarbon-based resin is selected from the group consisting of cyclopentadiene (abbreviated to CPD) or dicyclopentadiene (abbreviated to DCPD) homopolymer or copolymer resins, terpene homopolymer or copolymer resins, terpene/phenol homopolymer or copolymer resins, C₅ fraction homopolymer or copolymer resins, C₉ fraction homopolymer or copolymer resins, α-methylstyrene homopolymer or copolymer resins and mixtures of these resins. The term “terpene” groups together here, in a known way, α-pinene, β-pinene and limonene monomers; use is preferably made of a limonene monomer, a compound which exists, in a known way, in the form of three possible isomers: L-limonene (laevorotatory enantiomer), D-limonene (dextrorotatory enantiomer) or else dipentene, a racemate of the dextrorotatory and laevorotatory enantiomers. Among the above plasticizing hydrocarbon-based resins, mention will be made especially of α-pinene, β-pinene, dipentene or polylimonene homo- or copolymer resins.

Very preferentially, the hydrocarbon,-based resin used for the invention is mainly composed of units derived from C₅ monomers. The term “C₅ monomers” is understood to mean, according to the present invention and conventionally for those skilled in the art, the monomers resulting from C₄ to C₆ oil cuts. Suitable for example are 1,3 pentadienes, which may be cis and trans, pentenes, cyclopentadiene, cyclopentene, pyperylene, isoprene etc. This “Cs” resin, mainly composed of units derived from C₅ monomers, can comprise, in addition to these units, and in a minority capacity, aliphatic or aromatic units or else units of the aliphatic/aromatic type, that is to say based on aliphatic and/or aromatic monomers, other than C₅.

Preferably, for the invention, the content of hydrocarbon-based resin is within a range extending from 1 to 50 phr, preferentially from 5 to 30 phr.

Preferably, in the composition of the outer sidewall of the tyre of the invention, the amount of hydrocarbon-based resin is within a range extending from 7 to 25 phr, preferably from 8 to 20 phr.

Preferably, for the invention, the composition of the outer sidewall of the tyre of the invention does not comprise another resin than the C₅ resin described above.

Plasticizing Oil

Preferably, for the invention, the composition of the outer sidewall of the tyre of the invention does not comprise a plasticizing oil or comprises less than 25 phr of it.

Preferably, for the invention, the composition of the outer sidewall of the tyre of the invention does not comprise a plasticizing oil.

Alternatively, the composition can comprise a plasticizing oil. In this case, the amount of plasticizing oil is preferentially within a range extending from more than 0 to 25 phr, preferably from 3 to 15 phr.

Any plasticizing oil, sometimes also known as extender oil, whether it is of aromatic or non-aromatic nature, known for its plasticizing properties with regard to diene elastomers can be used. At ambient temperature (20° C.), these oils, which are more or less viscous, are liquids (that is to say, as a reminder, substances which have the ability to eventually assume the shape of their container), in contrast in particular to plasticizing hydrocarbon-based resins, which are by nature solids at ambient temperature.

Plasticizing oils selected from the group consisting of naphthenic oils (low or high viscosity, in particular hydrogenated or not), paraffinic oils, MES (Medium Extracted Solvates) oils, TDAE (Treated Distillate Aromatic Extracts) oils, mineral oils, vegetable oils, ether plasticizers, ester plasticizers, phosphate plasticizers, sulfonate plasticizers and mixtures of these compounds are particularly suitable.

For example, mention may be made of those which contain between 12 and 30 carbon atoms, for example trioctyl phosphate. Mention may in particular be made, as examples of non-aqueous and water-insoluble ester plasticizers, of the compounds selected from the group consisting of trimellitates, pyromellitates, phthalates, 1,2-cyclohexanedicarboxylates, adipates, azelates, sebacates, glycerol triesters and mixtures of these compounds. Among the above triesters, mention may be made of glycerol triesters, preferably predominantly composed (for more than 50%, more preferentially for more than 80%, by weight) of an unsaturated C18 fatty acid, i.e. selected from the group consisting of oleic acid, linoleic acid, linolenic acid, and mixtures of these acids. More preferentially, whether it is of synthetic origin or natural origin (case, for example, of sunflower or rapeseed vegetable oils), the fatty acid used consists of more than 50% by weight, even more preferentially of more than 80% by weight, of oleic acid. Such triesters (trioleates) with a high content of oleic acid are well known; they have been described, for example, in application WO 02/088238 as plasticizers in tyre treads.

Preparation of the Outer Sidewall of the Invention

In order to prepare the outer sidewall according to the invention, the elastomers are mixed, in a way known to those skilled in the art, with the other components of the outer sidewall, namely the carbon black, the polyethylene oxide, the wax, and also the crosslinking system and the optional other ingredients. Those skilled in the art will know how to adapt the order of incorporation of the ingredients (all at once or in several successive steps), the temperature and the compounding time.

Thus, for example, the following procedure is used for the tests: the elastomers, the carbon black, the polyethylene oxide, the wax and also the optional other ingredients, with the exception of the crosslinking system, are successively introduced into an internal mixer, approximately 70% (plus or minus 5%) filled and for which the initial vessel temperature is between 40° C. and 80° C. Thermomechanical working (non-productive phase) is then carried out in a step which lasts in total approximately from 3 to 4 minutes, until a maximum “dropping” temperature of 150° C. is reached.

The mixture thus obtained is recovered and cooled and then the crosslinking system, for example sulfur, and an accelerator are incorporated on an external mixer (homofinisher) at 30° C., everything being mixed (productive phase) for an appropriate time (for example between 5 and 12 min).

According to another embodiment, all the components, including the crosslinking system, can be introduced successively into the internal mixer as described above. In this case, the mixing has to be carried out up to a “dropping” temperature of less than or equal to 130° C., preferably of less than or equal to 120° C. and in particular of less than or equal to 110° C.

In some alternative embodiments, one or more of the elastomers (diene and/or thermoplastic) used in the composition can be introduced in the form of a masterbatch or premixed with some of the components of the composition.

The compositions thus obtained are subsequently calendered, either in the form of plaques (thickness from 2 to 3 mm) or thin sheets of rubber, for the measurement of their physical or mechanical properties, or extruded in the form of tyre outer sidewalls.

Use of the Outer Sidewall in a Pneumatic Tyre

The outer sidewall described above is particularly well suited to use as finished or semi-finished product made of rubber, very particularly in a pneumatic tyre for a motor vehicle, such as a vehicle of two-wheel, passenger vehicle or industrial type.

It will be easily understood that, according to the specific fields of application, the dimensions and the pressures involved, the embodiment of the invention can vary; the outer sidewall then comprises several preferred embodiments.

### EXAMPLES OF IMPLEMENTATION OF THE INVENTION

The outer sidewall described above can advantageously be used in pneumatic tyres for all types of vehicles, in particular passenger vehicles or industrial vehicles, such as heavy-duty vehicles.

By way of example, the single appended figure represents very diagrammatically (without observing a specific scale) a radial section of a pneumatic tyre in accordance with the invention.

This pneumatic tyre 1 comprises a crown 2 reinforced by a crown reinforcement or belt 6, two outer sidewalls 3 and two beads 4, each of these beads 4 being reinforced with a bead wire 5. The crown 2 is surmounted by a tread, not represented in this diagrammatic figure. A carcass reinforcement 7 is wound around the two bead wires 5 in each bead 4, the turn-up 8 of this reinforcement 7 being, for example, positioned towards the outside of the tyre 1, which is represented here fitted onto its wheel rim 9. The carcass reinforcement 7 is, in a manner known per se, formed of at least one ply reinforced with “radial” cords, for example made of textile or metal, that is to say that these cords are positioned virtually parallel to each other and extend from one bead to the other so as to form an angle of between 80° and 90° with the median circumferential plane (plane perpendicular to the axis of rotation of the tyre which is located midway between the two beads 4 and passes through the middle of the crown reinforcement 6).

The internal wall of the pneumatic tyre 1 comprises an airtight layer 10, for example with a thickness equal to approximately 0.9 mm, on the side of the internal cavity 11 of the pneumatic tyre 1.

The pneumatic tyre according to the invention can use, for example for the composition of its outer sidewall as defined above, a composition in accordance with the present invention.

The tyre provided with its outer sidewall as described above is preferably produced before crosslinking (or curing). The crosslinking is subsequently carried out conventionally.

An alternative manufacturing form which is advantageous, for a person skilled in the art of pneumatic tyres, will consist, for example during a first step, in depositing the airtight layer flat directly on a tyre-building drum, in the form of a skim of suitable thickness, before covering the latter with the remainder of the structure of the pneumatic tyre, according to manufacturing techniques well known to a person skilled in the art.

Tests

The properties of the elastomer compositions and of some of their constituents are characterized as indicated below.

The ozone resistance of the materials is measured according to the following method: after curing, the B15 test specimens are prepared. The “B15” test specimens result from an MFTR (known as Monsanto) plaque, the two beads of which located at the ends are used to hold the test specimen. The “B15” test specimens have the following dimensions 78.5 mm×15 mm×1.5 mm. After 240 hours of exposure to a temperature of 38° C. and an ozone level of 50pphm (parts per hundred million), the test specimens are placed on a trapezium-shaped support, and the maximum extension, beyond which the sample breaks, is measured in steps of 10% elongation. The result used is the maximum extension that the samples withstood without breaking during exposure to ozone. The higher this extension, the better the resistance of the material.

Measurement of the dynamic properties (after curing) The dynamic properties G* and G″ are measured on a viscosity analyser (Metravib V A4000), according to Standard ASTM D 5992-96. The response of a sample of vulcanized composition (cylindrical test specimen with a thickness of 2 mm and a cross section of 78.5 mm²), subjected to a simple alternating sinusoidal shear stress, at a frequency of 10 Hz, at a temperature of 23° C. and according to Standard ASTM D 1349-99, is recorded. A peak-to-peak strain amplitude sweep is performed from 0.1% to 50% (outward cycle) and then from 50% to 1% (return cycle). For the return cycle, the value of G* at 20% strain and also the value of G″ at 20% strain are indicated. The results used are the complex dynamic shear modulus (G*), which indicates the stiffness and a reduced value of which represents better stiffness performance in the case of an FE mixture; and the loss modulus (G″), which indicates the hysteresis and an increased value of which represents increased hysteresis and decreased performance. For greater readability, the results will be shown in terms of performance in base 100, the value 100 being assigned to the control. A result of less than 100 indicates a decreased performance and, conversely, a result of greater than 100 will indicate an improved performance.

Tests

Outer sidewall compositions containing customary elastomers, reinforcing fillers and additives not in accordance with the invention (C1 and C2, Table 1) were prepared according to the methods known to those skilled in the art and similarly to the preparation of the compositions of the invention described above. These control compositions were compared with a composition (C3 of Table 1) in accordance with the invention.

Table 1 shows all of the compositions prepared. The contents are all expressed in phr.

TABLE 1

| Compositions | C1 | C2 | C3 |
|---|---|---|---|
| Natural rubber (NR) (1) | 35 | 0 | 0 |
| Polybutadiène (BR) (2) | 65 | 75 | 75 |
| SBS (3) | 0 | 25 | 25 |
| Carbon black (4) | 50 | 25 | 25 |
| PEG (5) | 0 | 0 | 1.5 |
| Wax (6) | 1 | 1 | 1 |
| Oil (7) | 20 | 15 | 15 |
| Antioxidants (8) | 3 | 3 | 3 |
| Stearic acid | 1 | 1 | 1 |
| Zinc oxide | 3 | 2.5 | 2.5 |
| Sulfur | 1.4 | 1.2 | 1.2 |
| Accelerator (9) | 1.4 | 1.2 | 1.2 |

Table 1 references:
(1) NR Natural rubber
(2) Butadiene Rubber Nd
(3) SBS block copolymer, “D1101” from Kraton
(4) Carbon black N550
(5) PEG-400, “Pluriol FT E 400” from BASF
(6) Anti-ozone wax, “Varazon 4959” from Sasol Wax
(7) MES oil from Exxon Mobil
(8) Antioxidants: Santoflex 6PPD from Solutia and Vulkanox IPPD from Bayer
(9) N-Cyclohexyl-2-benzothiazolesulfenamide, Santocure CBS from Solutia

The compositions were tested according to the tests described above for performance in terms of resistance to ozone, stiffness (G*) and hysteresis (G″).

Table 2 shows all of the results of the compositions tested.

TABLE 2

| Compositions | C1 | C2 | C3 |
|---|---|---|---|
| Maximum extension | 50% | 100% | No break |
| after 240 h ozone | | | |
| G″ MAX return at 23° C. | 100 | 169 | 169 |
| G* at 10% of def at 23° C. | 100 | 100 | 100 |

The results presented in Table 2 show that only composition C3, in accordance with the invention, makes it possible to prevent breaking of the samples subjected to an ozone attack and therefore exhibits very good resistance to ozone. The composition also exhibits an improved balance between stiffness performance and hysteresis performance.

1.-15. (canceled)

16. A tire provided with an outer sidewall, the outer sidewall comprising at least one composition based on:
at least one thermoplastic elastomer comprising at least one elastomer block and at least one thermoplastic block;
a butadiene elastomer;
10 to 100 phr of carbon black;
0.6 to 1.9 phr of polyethylene oxide with a weight-average molecular weight Mw within a range extending from 250 to 550 g/mol; and
a crosslinking system.

17. The tire according to claim 16, wherein the at least one thermoplastic elastomer comprises a non-hydrogenated or partially hydrogenated unsaturated elastomer block selected from the group consisting of polyisoprenes, polybutadienes, copolymers of styrene and of butadiene, and mixtures thereof.

18. The tire according to claim 16, wherein the at least one thermoplastic elastomer comprises a thermoplastic block selected from the group consisting of polyolefins, polyurethanes, polyamides, polyesters, polyacetals, polyethers, polyphenylene sulfides, polyfluorinated compounds, polystyrenes, polycarbonates, polysulfones, poly(methyl methacrylate), polyetherimide, thermoplastic copolymers, and mixtures thereof.

19. The tire according to claim 16, wherein the at least one thermoplastic elastomer is selected from the group consisting of styrene/butadiene/styrene, styrene/isoprene/styrene and styrene/optionally partially hydrogenated butadiene-styrene copolymer/styrene block copolymers, and mixtures thereof.

20. The tire according to claim 16, wherein the at least one thermoplastic elastomer is selected from the group consisting of styrene/butadiene/styrene and styrene/partially hydrogenated butadiene-styrene copolymer/styrene block copolymers, and mixtures thereof.

21. The tire according to claim 16, wherein a content of the at least one thermoplastic elastomer is within a range extending from 5 to 45 phr.

22. The tire according to claim 16, wherein a content of butadiene elastomer is within a range extending from 55 to 95 phr.

23. The tire according to claim 16, wherein the butadiene elastomer is selected from the group consisting of polybutadienes, butadiene/styrene copolymers and mixtures thereof.

24. The tire according to claim 16, wherein the butadiene elastomer is selected from the group consisting of polybutadienes and mixtures thereof.

25. The tire according to claim 16, wherein the total amount of carbon black is within a range extending from 20 to 60.

26. The tire according to claim 16, wherein the weight-average molecular weight Mw of the polyethylene oxide is within a range extending from 300 to 500 g/mol.

27. The tire according to claim 16, wherein the amount of polyethylene oxide is within a range extending from 0.7 to 1.8 phr.

28. The tire according to claim 16, wherein the at least one composition further comprises an anti-ozone wax in an amount within a range extending from 0.2 to 10 phr.

29. The tire according to claim 28, wherein the anti-ozone wax contains from 50% to 75% of linear alkanes comprising 30 carbon atoms to 38 carbon atoms, relative to a total amount of linear alkanes.

30. The tire according to claim 16, wherein the at least one composition of the outer sidewall further comprises a hydrocarbon-based resin.
